(19) United States
(12) Patent Application Publication
(10) Pub. No.: US 2006/0106876 A1
(43) Pub. Date: May 18, 2006

(54) Method and apparatus for re-using presentation data across templates in an ontology

(76) Inventor: Robert M. MacGregor, Manhattan Beach, CA (US)

Correspondence Address: A. RICHARD PARK, REG. NO. 41241;PARK, VAUGHAN & FLEMING LLP, 2820 FIFTH STREET, DAVIS, CA, 95616, US

(21) Appl. No.: 11/271,728

(22) Filed: Nov. 10, 2005

Related U.S. Application Data
(60) Provisional application No. 60/627,343, filed on Nov. 12, 2004.

(51) Int. Cl. G06F 17/00

(52) U.S. Cl. 707/104.1

(57) ABSTRACT

One embodiment of the present invention provides a system that re-uses presentation data across templates in an ontology, wherein an ontology is a logic structure that defines semantics for a set of data, and wherein a template is a representation of a contextualized view of the meta-data of the ontology. During operation, the system produces a “decorated template” by associating paths in the template with decorations that describe how to present the set of data represented by the meta-data of the ontology. The system then attempts to identify matching paths in a second template. Any identified matching paths in the second template are associated with the decorations for corresponding matching paths from the decorated templates, thereby automatically attaching information from a path in the decorated template to a matching path in the second template.

### RELATED APPLICATION

This application claims priority under 35 U.S.C. §119(e) to U.S. Provisional Application Ser. No. 60/627,343, entitled “Dimension Trees: A Scheme for Reusable Application Profiles,” by inventor Robert MacGregor, filed on Nov. 12, 2004, the contents of which are herein incorporated by reference (Attorney Docket No. SIDE04-0001PSP).

### BACKGROUND

1. Field of the Invention

The present invention relates to systems for searching through collections of information resources. More specifically, the present invention relates to a method and an apparatus for re-using presentation data across templates in an ontology.

2. Related Art

Efficient organization and management of data is essential to modern commerce. In order to compute effectively, companies must be able to link diverse sets of data together into coherent structures that can be navigated and searched efficiently. An important aspect of this problem is identifying and understanding the relationships between such structures. In traditional database systems, the data tables use a schema that describes the structure of the data contained in the database. This schema contains meta-data that describes other (instance) data. In another example, XML documents contain both data and a definition of the syntactic structure of what constitutes a legal document. Another structure that can be used to describe the organization of data is an “ontology”.

An ontology is a logic structure that attempts to formulate an exhaustive and rigorous conceptual schema for a domain and thereby capture the semantics of a data set. Ontologies define traits and links between classes of objects and their neighbors, thereby establishing some conceptual context for objects. However, traditional ontologies do not look past the immediate neighbors of a class, and the semantics of every link are invariate regardless of the viewpoint in the graph of objects. Furthermore, traditional ontologies focus purely on semantics, i.e. the meaning of the data, and do not include any information describing how to present that data to an application or user. Consequently, different viewpoints, or templates, of the same logical relationships do not share any context or presentation data.

Hence, what is needed is a method and an apparatus for re-using presentation data across templates in an ontology.

### SUMMARY

One embodiment of the present invention provides a system that re-uses presentation data across templates in an ontology, wherein an ontology is a logic structure that defines semantics for a set of data, and wherein a template is a representation of a contextualized view of the meta-data of the ontology. During operation, the system produces a “decorated template” by associating paths in the template with decorations that describe how to present the set of data represented by the meta-data of the ontology. The system then attempts to identify matching paths in a second template. Any identified matching paths in the second template are associated with the decorations for corresponding matching paths from the decorated templates, thereby automatically attaching information from a path in the decorated template to a matching path in the second template.

In a variation on this embodiment, a path in the decorated template is characterized by a signature which specifies a set of items with types and a set of links between the items along the path.

In a further variation, the system stores a decoration and the characteristics of its associated path in a library.

In a further variation, the system compares a path in an undecorated template with a set of stored paths and decorations in the library. If the path in the undecorated template matches a path in the library, the path in the undecorated template is decorated with the decoration associated with the matching path in the library.

In a further variation, if multiple paths in the library match an undecorated path in the template, the system associates the undecorated path with the decoration of the most specific matching path in the library. The system determines which path is most specific by using a resolution mechanism.

In a further variation, the resolution mechanism determines a first matching path is more specific than a second matching path if the first matching path is longer than the second matching path. If the paths are the same length, the resolution mechanism determines the first matching path is more specific than the second matching path if the items and links in the first matching path have more specific types and properties than the items and links in the second matching path.

In a variation on this embodiment, the system decorates the ontology with non-semantic presentation data that is used in a principled fashion in conjunction with semantic data to operate on and display a set of data.

In a further variation, the decorated template allows a contextualized view of the ontology that provides hints for improved display of the data represented by ontology. The use of paths allows views of the ontology to extend beyond the immediate neighbors of items and allows a conceptual context to be set up for every item class or type.

In a variation on this embodiment, the decorated template is a query specified using the XRBR language.

### BRIEF DESCRIPTION OF THE FIGURES

FIG. 1 illustrates an example of an undecorated template viewed from the perspective of the type ex: Book in accordance with an embodiment of the present invention.

FIG. 2 illustrates an example of a decorated template viewed from the perspective of the type ex: Book in accordance with an embodiment of the present invention.

FIG. 3 illustrates a undecorated template viewed from the perspective of the type ex: Author in accordance with an embodiment of the present invention.

FIG. 4 illustrates a template that has inherited label information from a decorated faceted template with a different view in accordance with an embodiment of the present invention.

FIG. 5 illustrates a sample template for retail products in accordance with an embodiment of the present invention.

FIG. 6 illustrates the generation of decorated templates using a library in accordance with an embodiment of the present invention.

FIG. 7 illustrates a faceted navigation application in accordance with an embodiment of the present invention.

FIG. 8 presents a flow chart illustrating the method for decorating a path in an undecorated template using a library in accordance with an embodiment of the present invention.

Table 1 illustrates the method for inheriting presentation decorations onto paths for a set of XRBR templates in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs).

Ontologies and Facets

The present invention extends the traditional notion of an ontology to include presentation data and thereby provide a more contextualized view of data. A data system typically comprises data and a set of meta-data that describes the relationships between portions of the data. Just as the underlying data has a set of relationships, so too does the meta-data have a web-like set of relations.

In one embodiment of the present invention, the system provides a different way to display meta-data and data based on the type and view of the data. The system adds a set of decorations to the meta-data to convey information about the relationships between different facets of the meta-data. The system also provides a mechanism by which these decorations can easily be applied to different views of the meta-data without human interaction or re-specification, so that the decorations do not need to be re-created every time the context changes.

A “faceted template” is a semantic structure that provides a cognitive and physical medium for capturing an important class of presentation data (also referred to as application profile data). Faceted templates formalize the semantics that underlie XRBR (Xml Retrieval By Reformulation) queries and enable an architecture that migrates presentation data out of XRBR queries and into managed meta-data storage. Each faceted template essentially maps to a XRBR query. Multiple XRBR queries into the same data set provide different, overlapping ways of viewing the data. By overlaying these templates on the data, the system provides insight into the data's meaning and how it might be displayed. Each of the different presentation schemes can use different words or terms to describe the data to the system or user.

The faceted templates provide scaffolding for mapping XML data into a resource description framework (RDF) that forms a semantic web of data. Templates also provide a scheme for establishing the proper context for semiotic data, which leads to the ability to dynamically synthesize views that integrate multiple sources of semiotic and other profile data. The present invention describes faceted templates, introduces the notion of a “facet signature”, and provides examples of application profile data that can be attached to a faceted template.

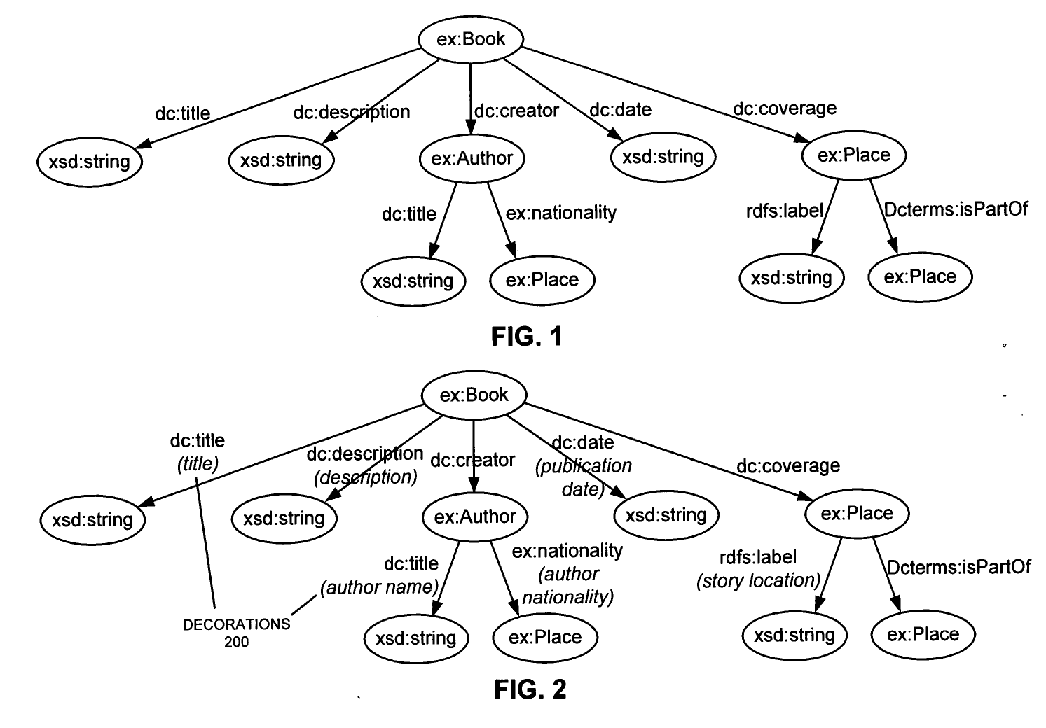

FIG. 1 shows an example of an (undecorated) template in the form of a tree composed of items and edges that show data about books. Each item node is labeled with an RDF type (class), and each edge is labeled with an RDF property. The tree structure defines a schema, but not of the kind found in most ontologies. The tree defines a partitive (part/subpart) hierarchy, as opposed to a superclass/subclass hierarchy, which enables the expression of contextualized semantics not possible in any other systems. The tree structures can extend to any arbitrary depth, thereby overlaying any number of semantic relationships. This is different, for instance, from a view in a relational database, which would be flat (i.e., the corresponding tree structure has depth one). The template can be applied to any structured form of underlying data, including data stored in a relational database or some other structure.

Each downward path to an item in the tree defines a facet. Nominally, all paths originate at the root node (exceptions are discussed later). For example, the paths:
(ex:Book>dc:title) and
[ex:Book>dc:creator>dc:title]
   represent two facets associated with the RDF class ex:Book. A template's utility increases when it is decorated with application profile data. For example, a simple kind of profile data specifies user-friendly labels that an application would display in preference to the RDF “qnames” (e.g. dc:title, ex:Place) shown in FIG. 1. For example, consider an application designed to display data for books in tabular form with headings for title, description, author name, author nationality, publication date, and story location.

FIG. 2 shows the same faceted template of FIG. 1 with user-friendly decoration labels (decorations 200 are shown in parentheses) attached to the relevant facets. Note that the choice of label is dependent on the context. For example, the [ex:Book>dc:title] facet and the [ex:Book>dc:creator>dc:title] facet share the same last RDF property (dc:title), but one facet has the label “title” while the other has the label “author name”. Therefore, the system cannot get the desired labeling semantics by simply associating a label with an RDF property (e.g., by utilizing the rdfs:label property). Instead, each label is tied to the last property in a path (i.e., is tied to a facet).

For a second example of application profile data, suppose that a user requests to compress a display to show less information about each book's author. A likely choice would be to display the “author name” facet in preference to the “author nationality” facet. In this case, the facet [Book>dc:creator] would be specified to use the facet [Book>dc:creator>dc:title] as its “display facet”. Another example is the description for a person. While a definition of a person may consist of many pieces of information (e.g. last name, first name, age, birthday, etc), one use might prefer a display facet to simply display a person's name in a “last name, first name” format.

Note that a user typically constructs and decorates an initial template for a data set or constructs a library with decoration data. The benefits of the present invention stem from the re-use of information from these constructions in decorating successor templates.

Facet Signatures and Re-Use of Decorations

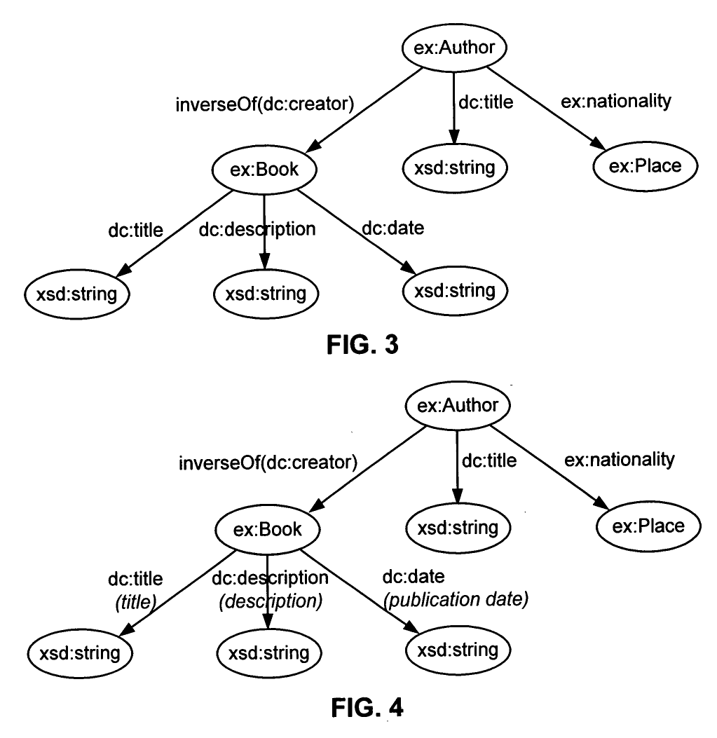

A key goal for faceted templates is that the attached decorations (application profile data) be re-usable for different situations. FIG. 3 shows another undecorated template representing the same data as FIG. 1, but this time viewed from the perspective of the type ex:Author instead of the type ex:Book (for example, in a faceted visualization and navigation system, a “pivot” could be used to obtain this perspective). Note that the location part of the tree is suppressed for simplicity.

Ideally, some or all of the decorations attached to the book perspective could be re-used when viewing data from the author perspective. However, only some of the decorations readily apply, and such re-use would need a systematic method that determines how to transfer the decorations from one template to another. The system translates decorations by exploiting the “signature” associated with each facet. While paths provide a useful approximation of signatures, facet signatures contain additional data. Specifically, a facet signature comprises of an alternating list of RDF types and RDF properties. While these resemble the facets referred to above, they also include a type between each property in the path, and a type at the end. An example would be [Book>dc:creator: ex:Author>dc:title: xsd:string]. For readability, the “>” and “:” characters are alternated in this document when specifying a signature. Signatures also allow for the specification of an inverse operator applied to a property (e.g., inverseOf (dc:creator)).

In FIG. 2, the label “publication date” was associated with the path [Book>dc:date]. This path exists in FIG. 3, although it does not extend all the way to the root (ex:Author). Hence, attaching the label “publication date” to the facet [Author>inverseOf(dc:creator)>dc:date] would be reasonable. This label would be more compelling if the last path made mention of the type ex:Book, and in fact the formal specification of facet signatures does includes the ex: Book type. FIG. 4 below shows the same tree with label information “inherited” from the tree in FIG. 2. Note that there is no structural sharing between the two templates; while the types and predicates are substantially similar for some paths, the graphs are independent.

Note that in FIG. 4, the labels “author name” and “author nationality” have disappeared. The signatures associated with those labels were both prefixed by [ex:Book>dc:creator], structure that is missing from the perspective of the template in FIG. 4. If those labels had been associated with shorter paths, e.g. ones that started from the ex: Author node rather than extending all the way to the root, then they would have been transferred as well. This illustrates how context information comes into play; longer paths translate into narrower context, yielding greater precision but narrower applicability. Shorter paths yield greater applicability, but less selectivity. Templates can also support decorations not explicitly attached to signatures, but these decorations cannot be migrated to other templates.

The other piece of (non-visible) data associated with the template in FIG. 2 was the assertion that the [Author>dc:title] facet provides a good way of displaying ex:Author data in compressed form. This attachment also fails to make the transition into FIG. 4, for the same reason—it is associated with a path extending back to the ex:Book node. Tools can be designed to avoid this kind of failure. Although paths (signatures) extend up to the root node by default, such tools can allow users to specify shorter paths when decorating faceted templates. In this case, the path length would be specified on a case-by-case basis, and different profile data associated with the same node in a tree might be paired with signatures of differing length. For the case of the display facet data just discussed, specifying the path [Author>dc:title] while attaching the data into the ex:Book tree would readily transfer into the ex:Author tree, achieving the desired re-use.

The inclusion of types into facet signatures has two advantages:
Associating a type with each node in the tree provides a “hook” that signatures can latch onto. For example, within the tree rooted at ex:Book, the type ex:Author is visibly associated with an internal node in that tree. Any signatures that begin with the ex:Author type are candidates for matching to that particular position within the ex:Book tree. If a type appears in multiple places within a tree, the same signature has the opportunity to attach to multiple places as well.
Types increase the expressivity of signatures. Consider the case when multiple dcterms:isPartOf edges emanate from a single node in a tree, differentiated by different types at their end-points. The type specification in a signature enables it to determine with which of the edges it can match. If desired, a type can be effectively nullified by specifying the general type owl:Thing. owl:Thing provides a “wild card,” since it is completely general and thus matches all other types.
   A language with even more expressivity, such as a language that emulates an XPath specification, could be used for facet signatures if greater expressivity is necessary.

Each facet in a facet tree is associated with a signature that by default extends from the root down to its position within the tree. Because these signatures are composed of types and properties that are linked to URIs, they are globally invariant; their semantics are rigidly specified independent of the application or tool where they were created. This invariance is another key to their re-usability. In contrast, the XRBR equivalent of a facet is identified by a locally-defined name (e.g., “book”, “author”). Profile data associated with an XRBR specification cannot be reliably transferred from one application to another. In addition, the semantics of XRBR facets do not include types, except at the root of a tree, and they do not allow for inverses of properties. Hence, the present facet signature mechanism represents a significant upgrade to the XRBR approach to managing application profile data.

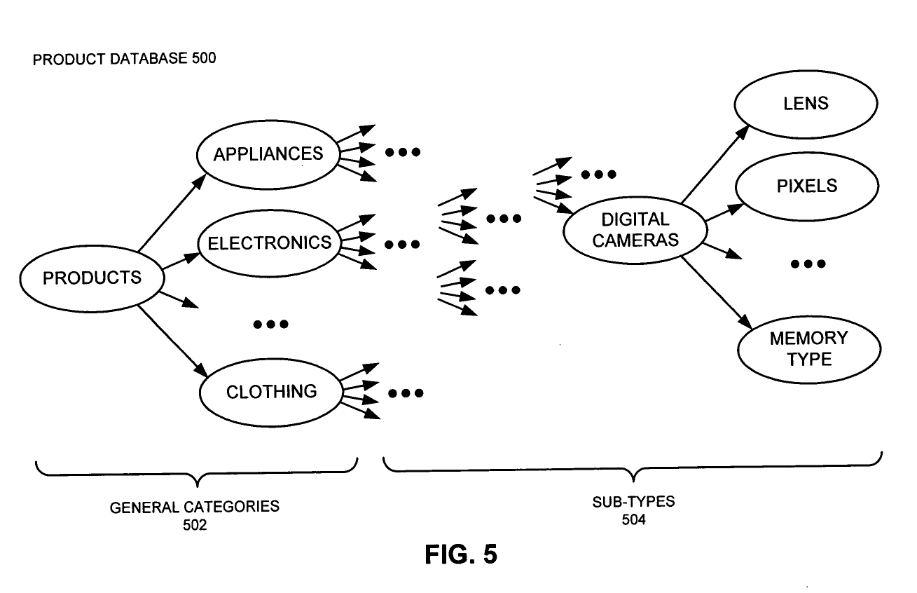

FIG. 5 illustrates a more complex sample template for retail products. A product database 500 contains a large set of data describing products for sale. The view from the root of the template first spans general categories 502 before eventually narrowing down to very specific sub-types 504. The nature of the template allows fields to be defined for the sub-types 504 at the bottom of the tree that would not make sense at the top level, for instance the lens, pixels, and memory type fields for digital cameras. Templates with different viewpoints into the same data set are likely to find a considerable amount of overlap in signatures. For a large database, creating such different templates and copying decorations into them manually would require a significant amount of effort. Furthermore, propagating changes from one template to all of the other related templates would also involve considerable effort. The amount of maintenance needed to keep such a system operational can be reduced using a method by which the signatures of existing decorated templates and their associated decorations can be stored and applied to other templates.

Matching Signatures from a Library

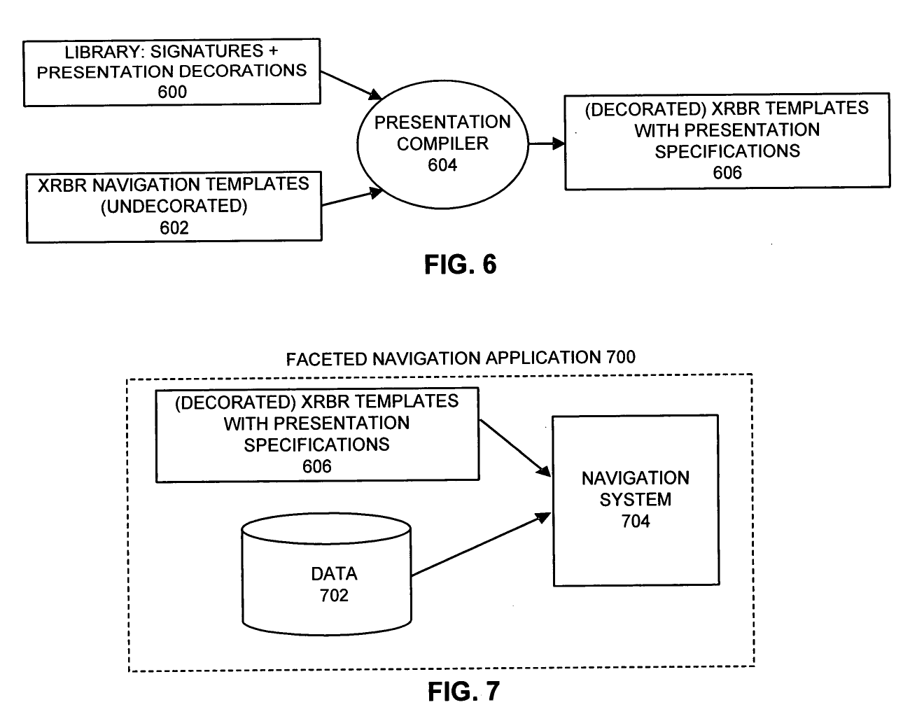

FIG. 6 illustrates the generation of decorated templates using a library. This library contains a set of signatures and associated presentation decorations 600 that can be gathered from existing decorated templates or created using other methods. A presentation compiler 604 uses the library 600 to transform a set of undecorated XRBR navigation templates 602 into a set of decorated XRBR templates with presentation specifications 606. The resulting templates can be used as part of the faceted navigation application 700 shown in FIG. 7. The system feeds the decorated templates 606 and the underlying data 702 they represent (often in RDF format) into a navigation system 704 (e.g. the Seamark navigation system). The decorated templates provide the navigation system with information that facilitates search, data presentation, and other data operations. An analogy to this in the relational database world would be a SQL language query processor, which also takes a set of meta-data (a schema) and data represented by that meta-data to provide a result, in this case the result of an SQL query.

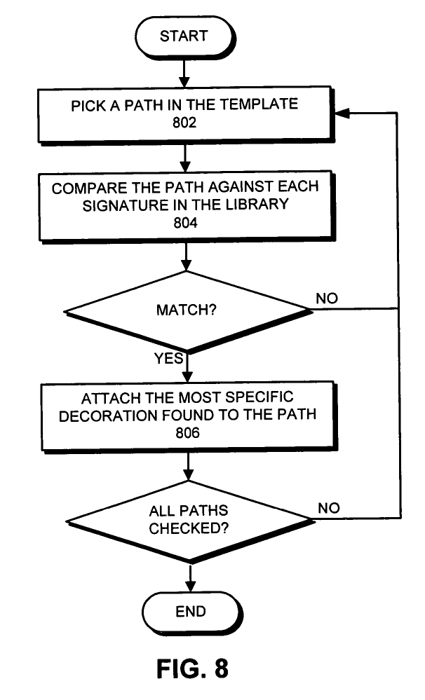

Table 1 illustrates in further detail the how of the presentation compiler 604 applies presentation decorations onto the paths of XRBR templates. FIG. 8 presents a flow chart illustrating the method for decorating a path in an undecorated template using a library. A path from the template is selected (step 802) and then compared against each signature in the library (step 804). Since items and links in the path may be defined using inheritance, the system incorporates a rigorous subsumption test that logically ensures that every link and item in the path has a subsumption relationship with the corresponding link or item in a given signature from the library in order for the path to match the given signature. Specifically, every item in the signature should have the same generality or be more general that the corresponding item in the path. If a set of matches is found, the decoration corresponding to the most specific match is attached to the leaf node of the undecorated path (step 806). The system compares all of the paths in each template to the library in this manner and outputs a set of templates decorated to the extent allowed by the contents of the library.

For a set of matches, the system selects the most specific match using a resolution mechanism. For instance, the system considers longer paths to be more specific than shorter paths. Also, as part of the subsumption test, for multiples paths of the same length a path whose item types more closely match the item types in the signature is also considered more specific.

TABLE 1
foreach XRBR template T do {

foreach path P in the template T do {

foreach signature S do {

if (P matches S) then {

foreach decoration D attached to S do {

Attach D to the end node N of P unless there
exists decoration D2 on N such that

(D and D2 belong to the same presentation
class
and the signature for D2 specializes S)

}

}

}

}

}

Characteristics of Decorations

The previous sections describe several different classes of application profile data. The system also handles several additional cases for decorations:
Default facets: The system allows selecting which facets should be displayed by default when viewing or asking for information for a particular class. For instance, the system can specify whether a field should be seen or not, in what order information should be displayed, and if a user wants to see more or less detail, which facets should be added or sacrificed, respectively.
Preferred label: The system allows a preferred label to be selected and displayed for each edge.
Inverse directions: The system allows labels to be attached when an edge is traversed in the inverse direction (e.g. inverseOf(dc:creater) in FIG. 4, on the edge where the ex:Author node looks towards ex:Book).
Types: The system overcomes any ambiguity when a node's type is rdfs:Resource (i.e. it is not a literal) by allowing the specification of the display facet.
Data width: In the case of display data that is too wide to fit in available space, the system provides a mechanism to determine which portion should be displayed or allows a “short name” to be specified.

Navigation instructions: The system allows the decorations to be associated with suggestions that can be used to give instructions to a navigation engine used to search or otherwise manipulate the data.

Modification: If an edit occurs, e.g. a literal value is changed, the system resolves what type of change is implied for the underlying data store. For example, in FIG. 1, if a user modifies the visible dc:title attribute for a book, the effect is to give the book a new title. However, if the user modifies the visible dc:title attribute for an author of some book, the effect could be to either change the specific author of that book, or to modify the author name (e.g. correct a typo in the author's name) for all of that author's books. In this case, the correct underlying action is not to change the name of that author but instead to locate another author (a RDF resource) whose dc:title attribute matches the new label, and to make an appropriate update to the book's dc:creator attribute.
Deletion: When a resource is deleted, the system determines how much of the network structure should be deleted with it. E.g., when an author is deleted, the system determines whether all information about the author should be deleted, or if the author name should simply no longer be associated with a specific book.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for re-using presentation data across templates in an ontology, wherein the ontology is a logic structure that defines semantics for a set of data, and wherein a template is a representation of a contextualized view of the meta-data of the ontology, comprising:
producing a decorated template by associating paths in the template with decorations that describe how to present the set of data represented by the meta-data of the ontology;
attempting to identify matching paths in a second template;
associating matching paths in the second template with decorations from corresponding matching paths in the decorated template;
whereby information attached to a path in the decorated template can be automatically attached to a matching path in the second template.

2. The method of claim 1, wherein a path in the decorated template is characterized by a signature which specifies a set of items with types and a set of links between the items along the path.

3. The method of claim 2, wherein a decoration and the characteristics of its associated path are stored in a library.

4. The method of claim 3, wherein the method further comprises:
comparing the path in an undecorated template with a set of stored paths and decorations in the library; and
if the path in the undecorated template is found to match a path in the library, decorating the path in the undecorated template with the decoration associated with the matching path in the library.

5. The method of claim 4, wherein if multiple paths in the library match an undecorated path in the template, the method further involves:
determining which matching path is most specific; and
associating the undecorated path with the decoration of the most specific matching path.

6. The method of claim 5, wherein determining which path is most specific involves:
determining a first matching path to be more specific than a second matching path if the first matching path is longer than the second matching path; and
determining the first matching path to be more specific than a third matching path if the items and links in the first matching path have more specific types and properties than the items and links in the third matching path.

7. The method of claim 1, wherein the method is used to decorate the ontology with non-semantic presentation data that is used in a principled fashion in conjunction with semantic data to operate on and display a set of data.

8. The method of claim 2,
wherein the decorated template allows a contextualized view of the ontology that provides hints for improved display of the data represented by ontology;
wherein the use of paths allows views of the ontology to extend beyond the immediate neighbors of items; and
wherein the use of paths allows a conceptual context to be set up for every item class or type.

9. The method of claim 1, wherein the decorated template is a query specified using the XRBR language.

10. A computer-readable storage medium storing instructions that when executed by a computer cause the computer to perform a method for re-using presentation data across templates in an ontology, wherein the ontology is a logic structure that defines semantics for a set of data, and wherein a template is a representation of a contextualized view of the meta-data of the ontology, the method comprising:
producing a decorated template by associating paths in the template with decorations that describe how to present the set of data represented by the meta-data of the ontology;
attempting to identify matching paths in a second template;
associating matching paths in the second template with decorations from corresponding matching paths in the decorated template;
whereby information attached to a path in the decorated template can be automatically attached to a matching path in the second template.

11. The computer-readable storage medium of claim 10, wherein a path in the decorated template is characterized by a signature which specifies a set of items with types and a set of links between the items along the path.

12. The computer-readable storage medium of claim 11, wherein a decoration and the characteristics of its associated path are stored in a library.

13. The computer-readable storage medium of claim 12, wherein the method further comprises:
comparing the path in an undecorated template with a set of stored paths and decorations in the library; and
if the path in the undecorated template is found to match a path in the library, decorating the path in the undecorated template with the decoration associated with the matching path in the library.

14. The computer-readable storage medium of claim 13, wherein if multiple paths in the library match an undecorated path in the template, the method further involves:
determining which matching path is most specific; and
associating the undecorated path with the decoration of the most specific matching path.

15. The computer-readable storage medium of claim 14, wherein determining which path is most specific involves:
determining a first matching path to be more specific than a second matching path if the first matching path is longer than the second matching path; and
determining the first matching path to be more specific than a third matching path if the items and links in the first matching path have more specific types and properties than the items and links in the third matching path.

16. The computer-readable storage medium of claim 10, wherein the method is used to decorate the ontology with non-semantic presentation data that is used in a principled fashion in conjunction with semantic data to operate on and display a set of data.

17. The computer-readable storage medium of claim 16, wherein the decorated template allows a contextualized view of the ontology that provides hints for improved display of the data represented by ontology;
wherein the use of paths allows views of the ontology to extend beyond the immediate neighbors of items; and
wherein the use of paths allows a conceptual context to be set up for every item class or type

18. The computer-readable storage medium of claim 10, wherein the decorated template is a query specified using the XRBR language.

19. An apparatus for re-using presentation data across templates in an ontology, wherein the ontology is a logic structure that defines semantics for a set of data, and wherein a template is a representation of a contextualized view of the meta-data of the ontology, comprising:
a production mechanism configured to produce a decorated template by associating paths in the template with decorations that describe how to present the set of data represented by the meta-data of the ontology;
an identification mechanism configured to attempt to identify matching paths in a second template;
an association mechanism configured to associate matching paths in the second template with decorations from corresponding matching paths in the decorated template;
whereby information attached to a path in the decorated template can be automatically attached to a matching path in the second template

20. The apparatus of claim 19, wherein a path in the decorated template is characterized by a signature which specifies a set of items with types and a set of links between the items along the path.
